(19) United States
(12) Patent Application Publication
(10) Pub. No.: US 2010/0253939 A1
(43) Pub. Date: Oct. 7, 2010

(54) Industrial Laparoscope

(76) Inventor: Chun-Yuan Chang, Tiachung City (TW)

Correspondence Address: Dr. BANGER SHIA;Patent Office of Bang Shia, 102 Lindencrest Ct, Sugar Land, TX, 77479-5201, US

(21) Appl. No.: 12/418,600

(22) Filed: Apr. 5, 2009

(51) Int. Cl. G01N 21/00

(52) U.S. Cl. 356/241.1

(57) ABSTRACT

An industrial laparoscope includes a handle and a socket connected to the handle. A hemisphere is partially, rotationally located in the socket. A button is connected to the hemisphere so that the button is operable to rotate the hemisphere. A gooseneck connected to the socket, a flexible tube connected to the gooseneck. A lens is connected to the flexible tube. A first wire spacer is located in the flexible tube. A second wire spacer is located in the flexible tube. A major spring is located in the flexible tube and compressed between the first and second wire spacers. At least four wires are inserted through the socket and the gooseneck. Each of the wires includes an end connected to the hemisphere and another end connected to the first wire spacer.

### FIELD OF INVENTION

The present invention relates to an industrial laparoscope and, more particularly, to an industrial laparoscope with an easily adjustable angle.

### BACKGROUND OF INVENTION

An industrial laparoscope is a tool for inspection. It includes a lens attached to an end of a gooseneck. The gooseneck is flexible so that the lens can be inserted into a narrow space for inspecting devices located in the narrow space. Thus, maintenance and repair can easily be conducted with information collected from the inspection.

In operation of the typical industrial laparoscope, the gooseneck is curbed to a desired shape before the insertion of the lens into the narrow space. To change the angle of the lens, the gooseneck is twisted on the outside of the narrow space. The angle of the lens is limited, and it is difficult to adjust the lens to a desired angle.

The present invention is therefore intended to obviate or at least alleviate the problems encountered in prior art.

### SUMMARY OF INVENTION

It is the primary objective of the present invention to provide an industrial laparoscope with an easily adjustable angle.

To achieve the foregoing objective, the industrial laparoscope includes a handle and a socket connected to the handle. A hemisphere is partially, rotationally located in the socket. A button is connected to the hemisphere so that the button is operable to rotate the hemisphere. A gooseneck connected to the socket, a flexible tube connected to the gooseneck. A lens is connected to the flexible tube. A first wire spacer is located in the flexible tube. A second wire spacer is located in the flexible tube. A major spring is located in the flexible tube and compressed between the first and second wire spacers. At least four wires are inserted through the socket and the gooseneck. Each of the wires includes an end connected to the hemisphere and another end connected to the first wire spacer.

Other objectives, advantages and features of the present invention will become apparent from the following description referring to the attached drawings.

### BRIEF DESCRIPTION OF DRAWINGS

The present invention will be described via detailed illustration of the preferred embodiment referring to the drawings.

FIG. 1 is a perspective view of an industrial laparoscope according to the preferred embodiment of the present invention.

FIG. 2 is an exploded view of the industrial laparoscope of in FIG. 1.

FIG. 3 is an enlarged partial view of the industrial laparoscope shown in FIG. 2.

FIG. 4 is a cutaway view of the industrial laparoscope of FIG. 1.

FIG. 5 is an enlarged partial view of the industrial laparoscope shown in FIG. 4.

FIG. 6 is an enlarged partial front view of the industrial laparoscope shown in FIG. 4.

FIG. 7 is a cross-sectional partial view of the industrial laparoscope shown in FIG. 6.

### DETAILED DESCRIPTION OF PREFERRED EMBODIMENT

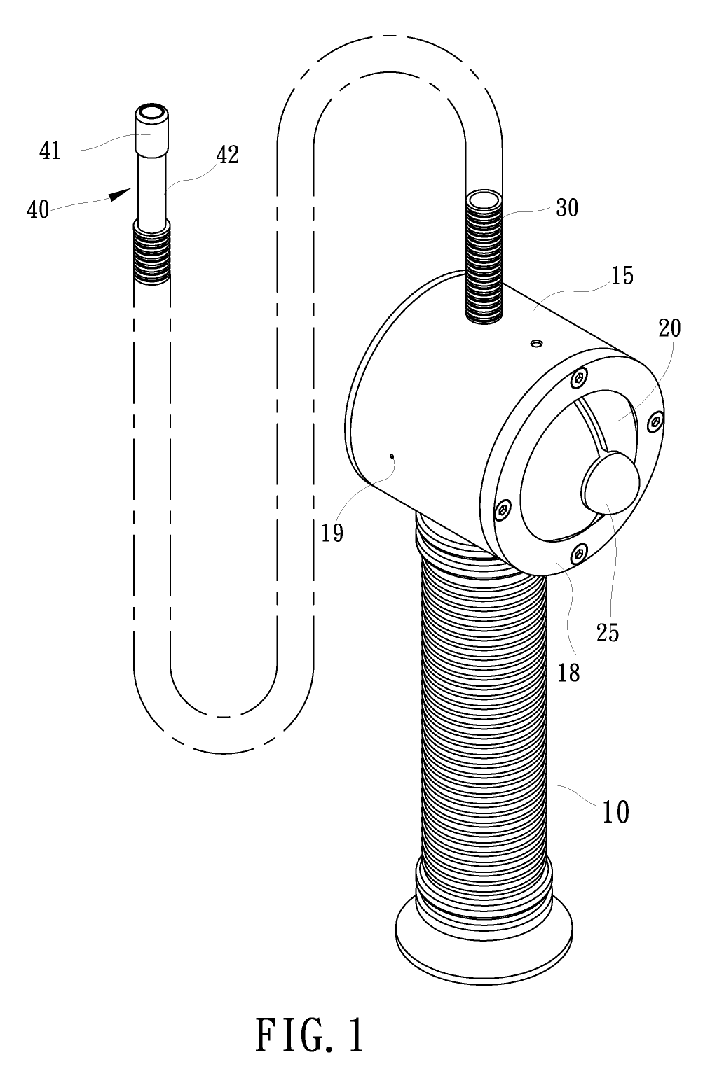

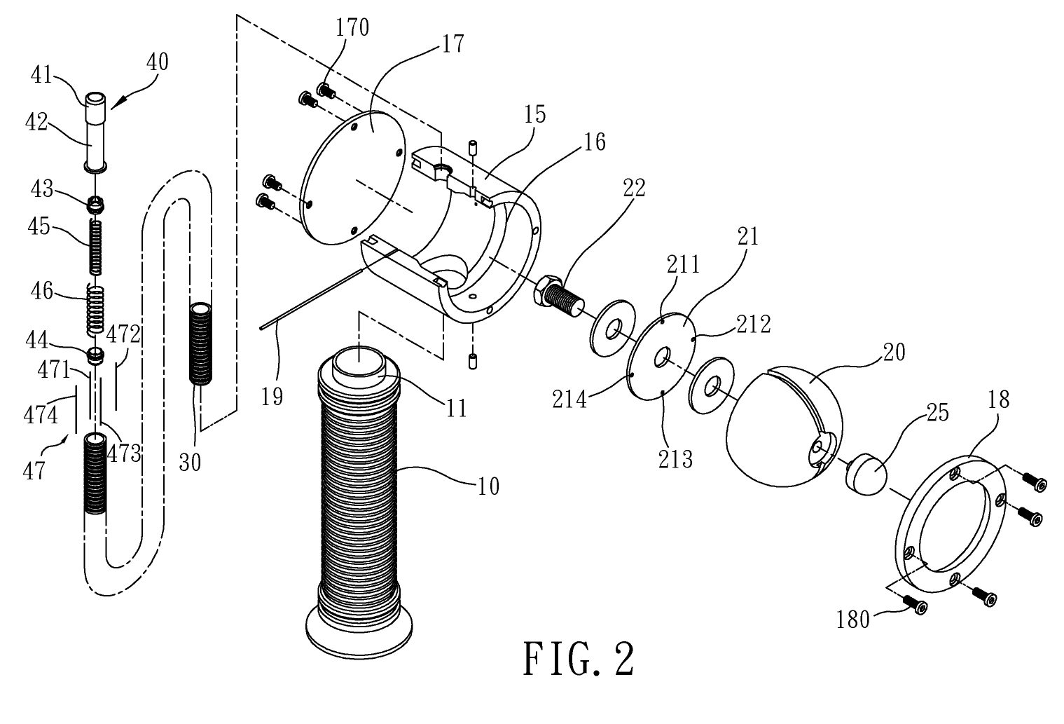

Referring to FIGS. 1 and 2, an industrial laparoscope includes a handle 10, a socket 15 connected to the handle 10, an adjusting device connected to the socket 15, a gooseneck 30 connected to the socket 15 and a viewing device 40 connected to the gooseneck 30 according to the preferred embodiment of the present invention. The socket 15 is attached to a reduced end 11 of the handle 10. The socket 15 includes two open ends and a cavity 16 defined therein near one of the open ends. A pin 19 is inserted through two opposite points of the socket 15 so that the pin 19 extends across the interior of the socket 15.

The adjusting device includes a hemisphere 20 partially, rotationally located in the cavity 16 through one of the open ends of the socket 15, a disc 21 connected to the hemisphere 20 and a button 25 connected to the hemisphere 20. Although called “hemisphere”, the element 20 is preferably larger than half a sphere. The hemisphere 20 is kept in the cavity 16 with a frame 18. The frame 18 is connected to the socket 15 with fasteners 180 such as screws. The disc 21 is attached to a plain side of the hemisphere 20 with a fastener 22 such as a screw. The disc 21 includes apertures 211, 212, 213 and 214 evenly defined therein.

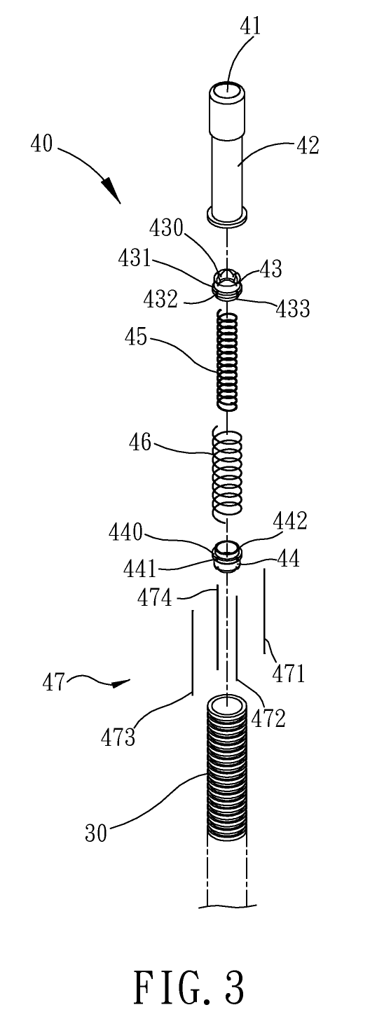

Referring to FIGS. 2 and 3, the viewing device 40 includes a lens 41, a flexible tube 42, wire spacers 43 and 44 and helical springs 45 and 46. The lens 41 is connected to an end of the flexible tube 42. Another end of the flexible tube 42 is connected to the gooseneck 30.

The wire spacers 43 and 44 are located in the flexible tube 42. The wire spacer 43 includes four cutouts 430 evenly defined in an end, a flange 431 formed on the periphery, four apertures 432 defined in the flange 431 and a reduced end 433. The wire spacer 44 includes a flange 440 formed on the periphery and four apertures 441 defined in the flange 440 and a reduced end 442.

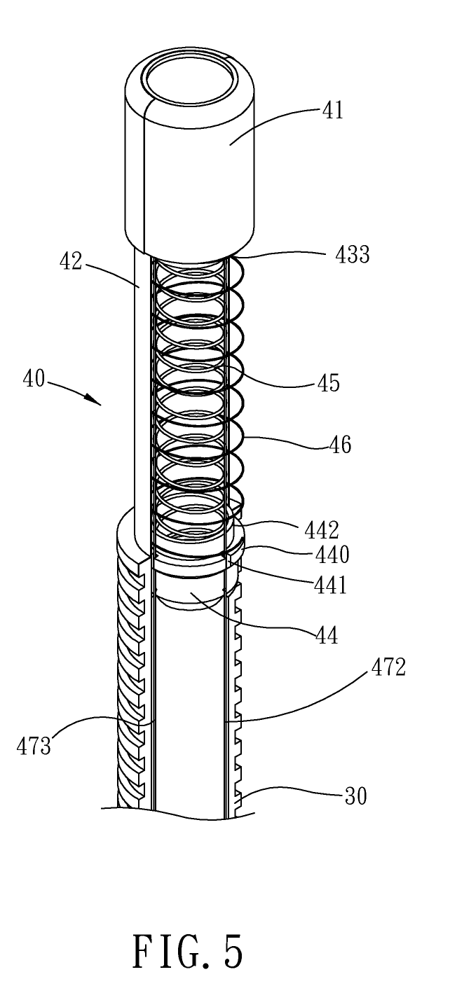

Referring to FIG. 5, the helical springs 45 and 46 are located in the flexible tube 42, between the wire spacers 43 and 44. The helical spring 45 is located in the helical spring 46. An end of the helical spring 45 is abutted against a shoulder formed on an internal side of the wire spacer 43. Another end of the helical spring 45 is abutted against a shoulder formed on an internal side of the wire spacer 44. The reduced end 433 of the wire spacer 43 is inserted in an end of the helical spring 46. The reduced end 442 of the wire spacer 44 is inserted in another end of the helical spring 46. The helical springs 45 and 46 are used to keep the flexible tube 42 straight.

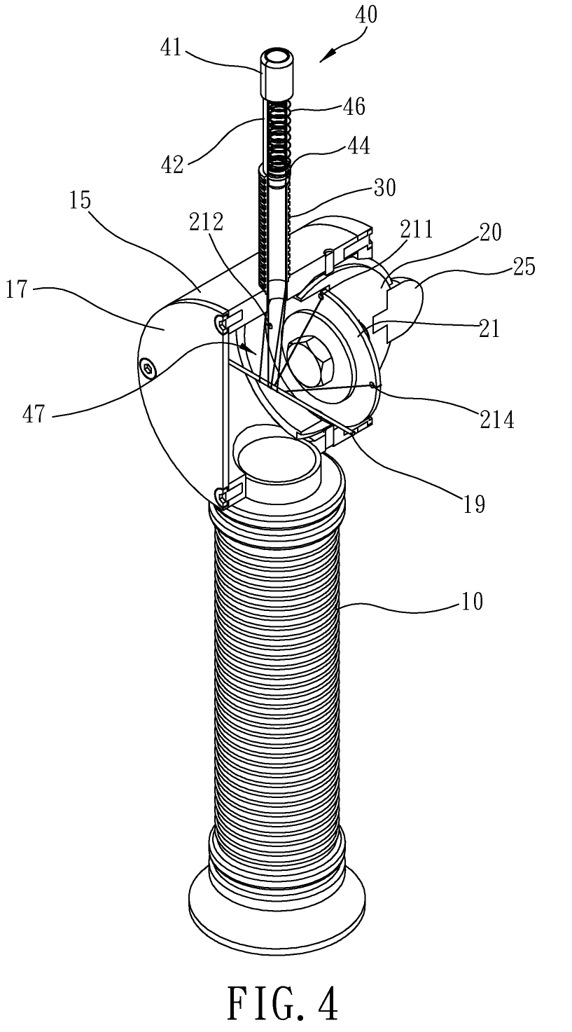

Referring to FIGS. 3 and 4, a connecting device 47 is used to connect the adjusting device to the viewing device 40. The connecting device 47 includes wires 471, 472, 473 and 474 inserted through the socket 15 and the gooseneck 30. An end of each of the wires 471 to 474 is inserted through a related one of the apertures 211 to 214 and secured to the disc 21. Another end of each of the wires 471 to 474 is inserted through a related one of the apertures 441, a related one of the apertures 432 and a related one of the cutouts 430 and secured to the wire spacer 43. The wires 471 to 474 are directed past the pin 19 so that the wires 471 to 474 extend for a same distance between the disc 21 and the wire space 43.

Referring to FIG. 2, a cover 17 is connected to the socket 15 with fasteners 170 such as screws. Thus, the other open end of the socket 15 is closed with the cover 17.

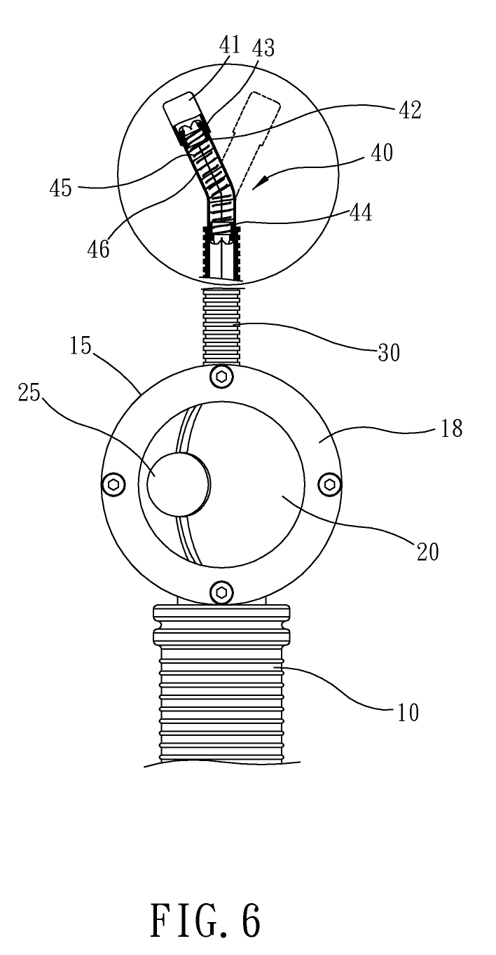

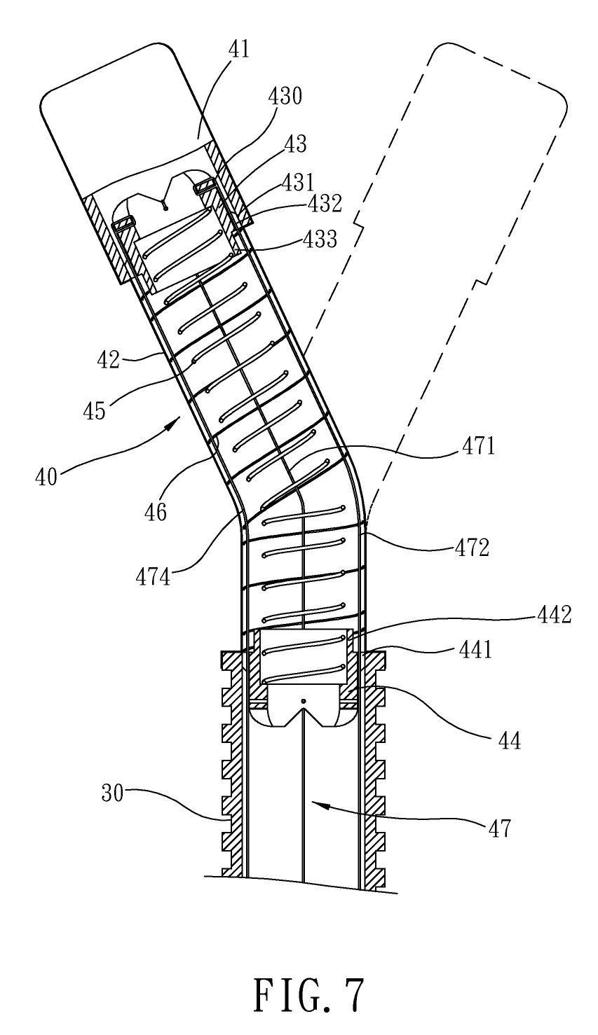

Referring to FIGS. 6 and 7, the button 25 is operable to rotate the hemisphere 20. The hemisphere 20 moves the disc 21. The disc 21 pulls some of the wires 471 to 474 while releasing the other wires. Thus, the flexible tube 42 and the helical springs 45 and 46 are bent so that the angle of the lens 41 is changed.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An industrial laparoscope comprising:
a handle;
a socket connected to the handle;
a hemisphere partially, rotationally located in the socket;
a button connected to the hemisphere so that the button is operable to rotate the hemisphere;
a gooseneck connected to the socket;
a flexible tube connected to the gooseneck;
a lens connected to the flexible tube;
a first wire spacer located in the flexible tube;
a second wire spacer located in the flexible tube;
a major spring located in the flexible tube and compressed between the first and second wire spacers; and
at least four wires inserted through the socket and the gooseneck, and each formed with an end connected to the hemisphere and another end connected to the first wire spacer.

2. The industrial laparoscope according to claim 1 comprising a pin extended across the interior of the socket, wherein the wires are direct past the pin so that the wires extend a same distance between the hemisphere and the first wire spacer.

3. The industrial laparoscope according to claim 1 comprising a minor spring located in the major spring and compressed between the first and second wire spacers.

4. The industrial laparoscope according to claim 1 comprising a disc connected to the hemisphere, wherein the wires are tied to the disc.

5. The industrial laparoscope according to claim 4, wherein the disc comprises apertures through which the wires are inserted.

6. The industrial laparoscope according to claim 1, wherein the first wire spacer comprises evenly located apertures through which the wires are inserted.

7. The industrial laparoscope according to claim 1, wherein the first wire spacer comprises evenly located cutouts through which the wires are inserted before the wires are tied to the first wire spacer.

8. The industrial laparoscope according to claim 1, wherein the second wire spacer comprises evenly located apertures through which the wires are inserted.

9. The industrial laparoscope according to claim 1 comprising a frame attached to the socket for keeping a portion of the hemisphere in the socket.
